(19) United States
(12) Patent Application Publication
(10) Pub. No.: US 2021/0018079 A1
(43) Pub. Date: Jan. 21, 2021

(54) ELECTROMECHANICAL BRAKE PRESSURE GENERATOR OR BOOSTER HAVING A THREADED DRIVE ASSEMBLAGE

(71) Applicant: Robert Bosch GmbH, Stuttgart (DE)

(72) Inventors: Martin Winkler, Sonthofen (DE); Sebastian Martin Reichert, Affaltrach (DE)

(21) Appl. No.: 16/915,175

(22) Filed: Jun. 29, 2020

(30) Foreign Application Priority Data
Jul. 18, 2019 (DE) 102019210669.2

(51) Int. Cl. F16H 25/24; F16H 25/20; B60T 13/16; F04B 53/00; F04B 19/04

(52) U.S. Cl. CPC F16H 25/24; F16H 25/20; F16H 2025/249; F04B 53/00; F04B 19/04; B60T 13/168

(57) ABSTRACT

An electromechanically drivable brake pressure generator for a hydraulic braking system of a vehicle, having at least one threaded drive assemblage for converting an input-drive-side rotary motion into a translational motion, and a piston/cylinder unit, actuatable by the threaded drive assemblage, for hydraulic brake pressure generation. The assemblage encompasses: a spindle that has a spindle thread; and a spindle nut that has a spindle nut thread, the spindle nut being disposed on the spindle thread of the spindle so that as one of the two spindle elements rotates, the other, which is prevented from twisting using a twist preventer, is axially displaceable. The spindle nut has a spindle nut body and at least one anti-friction layer made of plastic, which is applied on the spindle nut body and has a more pronounced anti-friction property than the spindle nut body, that anti-friction layer being applied on the spindle nut thread.

### CROSS REFERENCE

The present application claims the benefit under 35 U.S.C. § 119 of German Patent Application No. DE 102019210669.2 filed on Jul. 18, 2019, which is expressly incorporated herein by reference in its entirety.

The present invention relates to an electromechanical brake pressure generator for a hydraulic braking system of a vehicle.

This electromechanical brake pressure generator encompasses in particular a threaded drive assemblage for converting an input-drive-side rotary motion into a translational motion for hydraulic brake actuation.

The driver's foot force is usually not sufficient to brake motor vehicles, so that the latter are usually equipped with a brake booster. Conventional brake boosters operate generally with a negative pressure generated by the internal combustion engine. The pressure difference between the engine pressure and the ambient pressure is used in order to apply onto the piston rod of the piston/cylinder unit a boosting force in addition to the driver's foot force.

Alternative brake pressure buildup devices will be needed for future motor-vehicle drive system concepts, since the negative pressure for operating a conventional vacuum brake booster is no longer available. The electromechanical brake pressure generators of interest here were developed for that purpose.

The actuation force at the piston/cylinder unit is generated here with the aid of an electric motor. Electromechanical brake pressure generators of this kind can be utilized not only to furnish an auxiliary force but also, in brake-by-wire systems, to furnish all of the actuation force. Electromechanical brake pressure generators are therefore advantageous in particular with regard to autonomous driving.

### BACKGROUND INFORMATION

PCT Application No. WO 2017/045804 A1 describes a conventional electromechanical brake booster, which is depicted in FIG. 1. In contrast thereto, the present invention is directed toward an electromechanical brake pressure generator that can apply a braking force independently of an actuation of the brake pedal. The conventional brake booster 1 encompasses a spindle nut 2 and an electric motor (not depicted) upon operation of which a rotation can be imparted to spindle nut 2 via a spur gear 3. Spindle nut 2 is in working engagement with a spindle 4, with the result that spindle 4 can be caused, by way of spindle nut 2 to which rotation has been imparted, to move translationally along its spindle axis 5. In order for spindle 4 not to co-rotate due to the rotation of spindle nut 2, brake booster 1 has a bearing assemblage 6 to which spindle 4 is fixedly connected.

Bearing assemblage 6 encompasses a bracket 6a at whose edges two plain bearings 6b are disposed. Plain bearings 6b run on tie rods 7 that proceed substantially parallel to spindle axis 5. By way of this bearing assemblage 6, spindle 4 is movable in an axial direction and is secured against twisting.

### SUMMARY

The present invention provides an electromechanically drivable brake pressure generator for a hydraulic braking system of a vehicle, having at least one threaded drive assemblage for converting an input-drive-side rotary motion into a translational motion, and having a piston/cylinder unit, actuatable by the threaded drive assemblage, for hydraulic brake pressure generation. The threaded drive assemblage encompasses a spindle that has a spindle thread, and a spindle nut that has a spindle nut thread, the spindle nut being disposed on the spindle thread of the spindle in such a way that as one of the two spindle elements rotates, the other, which is prevented from twisting by way of a twist preventer, is axially displaceable.

The spindle nut has a spindle nut body and at least one anti-friction layer made of plastic, which is applied on the spindle nut body and has a more pronounced anti-friction property than the spindle nut body, that anti-friction layer being applied at least on the spindle nut thread.

A “threaded drive assemblage” is understood in the context of the present invention both as a plain spindle drive in which the spindle nut is in direct contact with the spindle, and as a ball screw drive. A ball screw drive is a screw linkage having balls introduced between the spindle and spindle nut. The two parts each have a screw-shaped groove, together forming a screw-shaped tube filled with balls. A positively engaged connection in the thread transversely to the screw line takes place not between the thread groove and threaded wall as in the case of a plain spindle drive, but via the balls.

An “anti-friction” layer is a material that is applied in layer form and has a thin wall thickness with respect to the body on which it is applied. Friction with respect to a component interacting dynamically with this layer is substantially decreased by this layer. The anti-friction property correspondingly depends on the coefficient of friction. The anti-friction layer preferably has self-lubricating properties. Emergency mode properties, in a context in which no direct lubrication exists, are thereby ensured.

The anti-friction layer has the advantage that it is possible to select, for the main body of the spindle nut, an optimal material that, for example, takes into account the stresses that occur and can additionally be economical, but despite that has rather poor anti-friction properties. A material that meets all criteria as a rule is usually expensive. In order nevertheless to achieve good anti-friction properties, a material having good anti-friction properties is additionally applied. That material is applied in a layer, however, so that only a small amount of material is needed. It is thereby possible to furnish an electromechanical brake pressure generator that can be manufactured more economically.

In a preferred embodiment of the present invention, the anti-friction layer has lower strength than the spindle nut body. Materials having high strength which additionally exhibit good anti-friction properties are generally expensive. The tribologically optimized anti-friction layer does not need to perform any structural, load-bearing functions. It is thus also possible to use low-strength materials for that layer. A corresponding electromechanical brake pressure generator can thereby be manufactured more economically.

In a further preferred embodiment of the present invention, the spindle nut body is made from metallic material. Metallic material has good strength, so that the dimensions of the spindle nut body can be decreased. A metallic material can furthermore be processed in simple fashion.

The spindle nut body is preferably made from a plastic material. Plastic material has the advantage that it is light and can easily be manufactured in a multiplicity of shapes. In addition, costs for plastic are low, so that all in all a brake pressure generator of this kind can be manufactured economically and is lighter as compared with other materials.

In an advantageous refinement of the present invention, the spindle nut body is fiber-reinforced. A fiber-reinforced spindle nut body additionally has fibers that extend in the direction of the principal loads and are embedded in the plastic. The forces are thus absorbed by the fibers. The spindle nut body is consequently reinforced, so that installation space and weight can additionally be reduced.

Advantageously, the spindle nut body has several twist preventers that form sliding surfaces, the anti-friction layer being applied onto the sliding surfaces. The sliding surfaces of the twist preventer are the surfaces that are in contact with a housing of the brake pressure generator. These surfaces slip along the housing during an axial motion. The axial resistance is additionally decreased by a corresponding low-friction layer, so that the torque of the spindle for axial motion of the spindle nut can be reduced. This in turn has an effect on the electric motor that is required.

In a further advantageous embodiment of the present invention, the spindle nut body is completely coated with the anti-friction layer, the entire outer surface being covered with an anti-friction layer. Possible contact with a cylinder in which the spindle nut is axially movable is thereby also improved. This has the additional advantage that an anti-friction layer of this kind can be manufactured more easily in the context of injection molding. An electromechanical brake pressure generator embodied with a spindle nut of this kind can thereby, in turn, be manufactured more economically.

According to an example embodiment of the present invention, a vehicle is provided which encompasses an electromechanically drivable brake pressure generator for a hydraulic braking system. The advantages recited above are achievable with such a vehicle.

Exemplifying embodiments of the present invention are explained in further detail in the description below and depicted in the figures.

### BRIEF DESCRIPTION OF THE DRAWINGS

FIG. 1 depicts an conventional electromechanical brake pressure generator from the related art.

FIG. 2 is a simplified schematic depiction of a conventional hydraulic braking system, from the related art, for a vehicle, having an electromechanical brake pressure generator.

FIG. 3 depicts a spindle/spindle nut unit of the threaded drive assemblage.

FIG. 4 is an enlarged depiction of the spindle nut thread on which an anti-friction layer is applied.

FIG. 5 is a partial perspective depiction of the spindle nut, having a twist preventer on which the anti-friction layer is applied.

FIG. 6 is a perspective view of a spindle nut on which an anti-friction layer is applied.

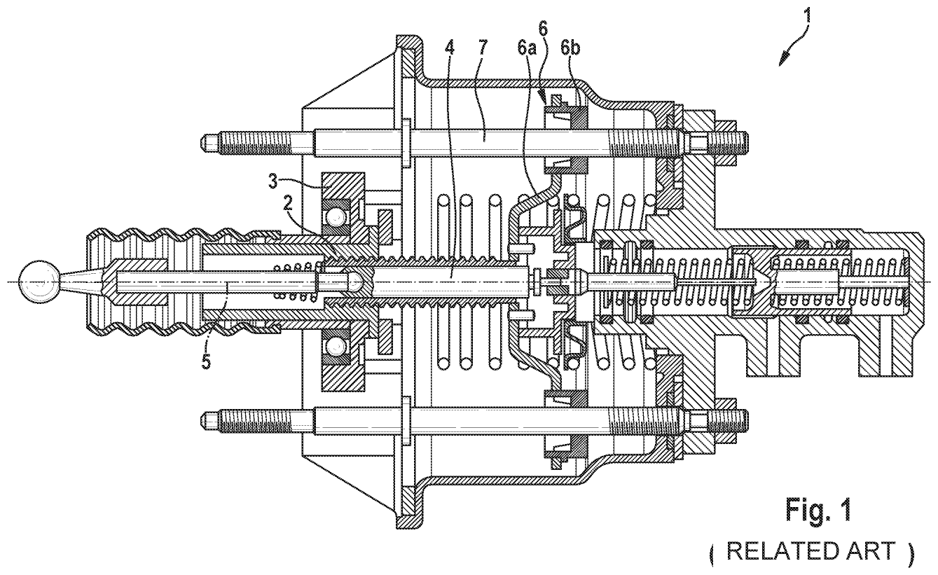

### DETAILED DESCRIPTION OF EXAMPLE EMBODIMENTS

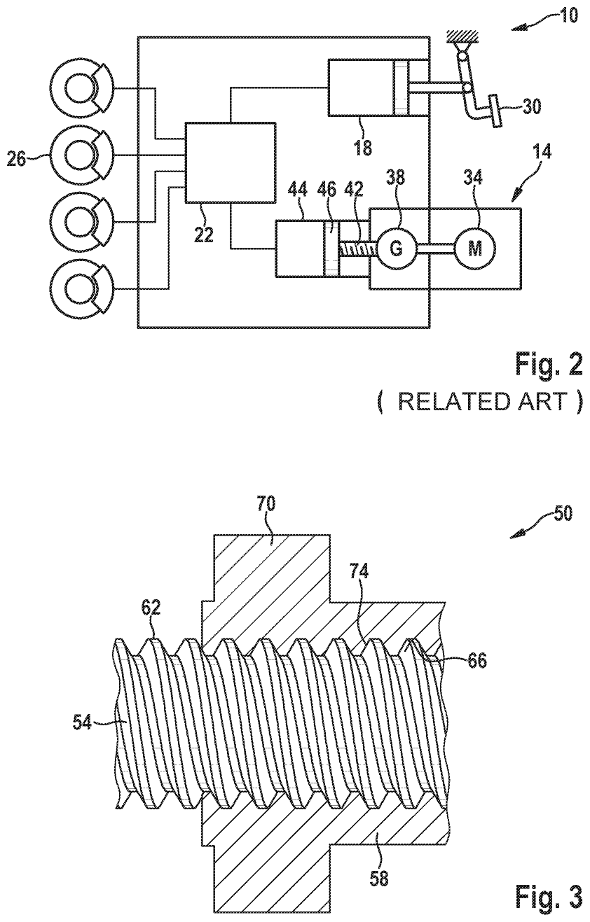

FIG. 2 is a simplified schematic depiction of a conventional hydraulic braking system 10, from the related art, for a vehicle, having an electromechanical brake pressure generator 14. Hydraulic braking system 10 encompasses electromechanical brake pressure generator 14 and a piston/cylinder unit 18. Piston/cylinder unit 18 and electromechanical brake pressure generator 14 are both hydraulically connected to a brake hydraulics unit 22 that is depicted here merely as a box.

Brake hydraulics unit 22 is configured, by way of various valves and further components, to embody, e.g., an electronic stability program (ESP). In order to allow the vehicle to be decelerated, brake hydraulics unit 22 is additionally connected to at least one wheel brake device 26 so that, by corresponding switching of valves, a braking force can be applied to wheel brake device 26.

Piston/cylinder unit 18 is actuated by muscle force via a brake pedal 30. In contrast thereto, the braking force of electromechanical brake pressure generator 14 is generated via an electric motor 34. Electric motor 34 is connected for that purpose to a linkage 38 by which a threaded drive assemblage 42 is driven. Threaded drive assemblage 42 is connected to a hydraulic piston 46 disposed in a hydraulic cylinder 44, so that a brake pressure can be generated.

FIG. 3 depicts a spindle/spindle nut unit 50 of threaded drive assemblage 42. FIG. 3 shows only a portion of spindle/spindle nut unit 50. A threaded drive assemblage 42 encompassing spindle/spindle nut unit 50 could be used in hydraulic braking system 10 shown in FIG. 2. Spindle/spindle nut unit 50 of threaded drive assemblage 42 encompasses a spindle 54 that is partly surrounded by a spindle nut 58.

Spindle 54 has a spindle thread 62 that is in engagement with a spindle nut thread 66 that is embodied on spindle nut 58. In this exemplifying embodiment, spindle nut 58 encompasses twist preventers 70 that project radially. These twist preventers 70 are in engagement with a housing (not shown). The result is that upon a rotation of spindle 54, spindle nut 58 does not rotate along with it. Spindle 54 is thereby axially displaceable.

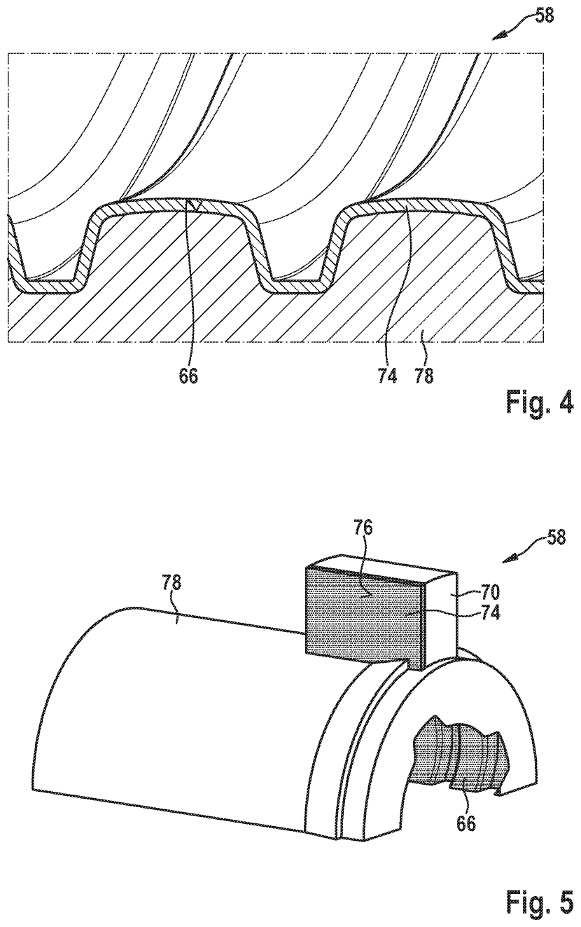

Spindle nut 58 additionally has an anti-friction layer 74 that is applied onto spindle nut thread 66 of a spindle nut body 78. FIG. 4 is, for that purpose, an enlarged view of a portion of spindle nut thread 66. For better illustration, spindle 54 has been omitted from this Figure. As shown in FIG. 4, a continuous anti-friction layer 74 made of plastic is applied onto spindle nut thread 66 of spindle nut body 78. This plastic has lubrication properties, so that an easier rotary motion of spindle 54 is possible and emergency mode properties are guaranteed.

FIG. 5 is a partial perspective depiction of spindle nut 58 having a twist preventer 70 on which an anti-friction layer 74 is applied. Only half of spindle nut 58 is depicted in this Figure. Anti-friction layers 74 are additionally applied onto sliding surfaces 76, which here are the longitudinal sides of twist preventers 70. Sliding surfaces 76 are the sides that abut, for example, against a housing in order to prevent twisting. During an axial motion of spindle nut 58, twist preventer 70 essentially slips along a corresponding surface of the housing. Anti-friction layer 74 makes possible easy slippage of twist preventers 70.

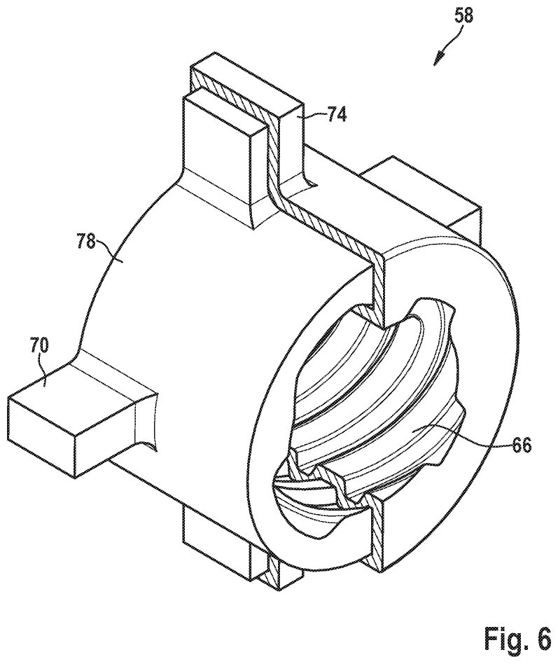

FIG. 6 is a perspective view of a spindle nut 58 on which an anti-friction layer 74 is applied. For spindle nut 58 shown in FIG. 6, anti-friction layer 74 is depicted only in section. In this exemplifying embodiment spindle nut 58 additionally has a total of four twist preventers 70. With this spindle nut 58, the entire spindle nut 58 has anti-friction layer 74. Sliding contact with all components with which spindle nut 58 is in contact is thereby improved. In addition, anti-friction layer 74 can more easily be applied onto spindle nut body 78, for example, in the course of injection molding.

What is claimed is:

1. An electromechanically drivable brake pressure generator for a hydraulic braking system of a vehicle, comprising:
at least one threaded drive assemblage configured to convert an input-drive-side rotary motion into a translational motion; and
a piston/cylinder unit, actuatable by the threaded drive assemblage, for hydraulic brake pressure generation;
wherein the threaded drive assemblage includes:
a spindle that has a spindle thread; and
a spindle nut that has a spindle nut thread, the spindle nut being disposed on the spindle thread of the spindle in such a way that as one of the spindle and spindle nut rotates, the other one of the spindle and spindle nut, which is prevented from twisting using a twist preventer, is axially displaceable;
wherein the spindle nut has a spindle nut body and at least one anti-friction layer made of plastic, which is applied on the spindle nut body and has a more pronounced anti-friction property than an anti-friction property of the spindle nut body, the anti-friction layer being applied at least on the spindle nut thread.

2. The electromechanically drivable brake pressure generator as recited in claim 1, wherein the anti-friction layer has lower strength than the spindle nut body.

3. The electromechanically drivable brake pressure generator (as recited in claim 1, wherein the spindle nut body is made from metallic material.

4. The electromechanically drivable brake pressure generator as recited in claim 1, wherein the spindle nut body is made from a plastic material.

5. The electromechanically drivable brake pressure generator as recited in claim 4, wherein the spindle nut body is fiber-reinforced.

6. The electromechanically drivable brake pressure generator as recited in claim 1, wherein the spindle nut body has several twist preventers that form sliding surfaces, the anti-friction layer being applied onto the sliding surfaces.

7. The electromechanically drivable brake pressure generator as recited in claim 1, wherein the spindle nut body is completely coated with the anti-friction layer.

8. A vehicle having an electromechanically drivable brake pressure generator for a hydraulic braking system, the electromechanically drivable brake pressure generator comprising:
at least one threaded drive assemblage configured to convert an input-drive-side rotary motion into a translational motion; and
a piston/cylinder unit, actuatable by the threaded drive assemblage, for hydraulic brake pressure generation;
wherein the threaded drive assemblage includes:
a spindle that has a spindle thread; and
a spindle nut that has a spindle nut thread, the spindle nut being disposed on the spindle thread of the spindle in such a way that as one of the spindle and spindle nut rotates, the other one of the spindle and spindle nut, which is prevented from twisting using a twist preventer, is axially displaceable;
wherein the spindle nut has a spindle nut body and at least one anti-friction layer made of plastic, which is applied on the spindle nut body and has a more pronounced anti-friction property than an anti-friction property of the spindle nut body, the anti-friction layer being applied at least on the spindle nut thread.
